(19) United States
(12) Patent Application Publication
(10) Pub. No.: US 2017/0267016 A1
(43) Pub. Date: Sep. 21, 2017

(54) Writing Board

(71) Applicant: Ningbo ZhiBao Stationery Co., Ltd, Ningbo (CN)

(72) Inventors: Feng Zhu, Ningbo (CN); Shouhua Ge, Ningbo (CN); Hailin Zheng, Ningbo (CN)

(73) Assignee: Ningbo ZhiBao Stationery Co., Ltd

(21) Appl. No.: 15/075,155

(22) Filed: Mar. 20, 2016

(51) Int. Cl. B43L 1/00; G09B 1/32

(52) U.S. Cl. CPC B43L 1/00; G09B 1/32

(57) ABSTRACT

The present invention discloses a writing board, solving the problems of large occupied space due to large area, high transportation cost, easy damage and high scrappage rate in the existing writing board. The writing board has the technical solution that the writing board comprises a body, wherein the body comprises a board body; the board body comprises a left board and a right board; the body also comprises fastening parts; locating parts fastened with the fastening parts are arranged on the left board and the right board; grooves are formed in the locating parts; each fastening part comprises an inverted hooking part; and the inverted hooking parts are embedded into the grooves. The writing board of the present invention has the advantages of reduction of transportation cost, convenient presentation, simple structure and convenient use and can be lengthened infinitely.

### TECHNICAL FIELD

The present invention belongs to the technical field of teaching aids, in particular relates to a writing board.

### BACKGROUND

At present, the existing writing boards on market are different in sizes, can be sold in the supermarket and the counter, and are mainly used for writing and showing in teaching. The writing boards with small size have no problem in the transportation process, but some writing boards with big size have the problems of high transportation cost and large occupied space. The big writing boards are easy to damage as the big writing boards are week in bearing capability due to large area, so that the scrappage rate is high; once the writing boards are too big to be loaded in a vehicle of a customer or a transportation vehicle, the purchase desire of the customer can be affected. In order to solve the above problems, a folding type writing board exists on market. Two writing boards are connected by a common hinge to form an entire writing board, solving the problem of large occupied space and convenient transportation and presentation; but because the hinge needs to be auxiliarily fixed by a screw, the installation is troublesome. Moreover, the two writing boards are movably connected and fixed by the common hinge, and thus are not stable in the unfolding state. The entire writing board is usually fixed on a wall by virtue of a fixing device, causing that the folding type writing board is more complex in structure and use.

The utility model of China with the application number of the patent 200620154257.3 discloses a folding type writing board. Two boards are movably connected by an elastic locating hinge instead of a common hinge, wherein the elastic locating device is formed by a spring and a rolling ball; when the two writing boards are unfolded or folded, the rolling ball is located between two hinge piece ball holes and has the locating function under the action of the spring. Although the patent solves the problems of high transportation cost and instability of the writing board in the unfolding state, the folding type writing board is still complex in structure and is not beneficial for use.

### SUMMARY OF THE PRESENT INVENTION

Aiming at the defects existing in the prior art, the present invention aims to provide a writing board which has the beneficial effects of reduction of the transportation cost and convenient presentation. Moreover, the writing board is simple in structure and convenient in use and can be lengthened infinitely.

In order to achieve the purposes, the present invention provides the following technical solution: the writing board comprises a body, wherein the board body comprises a board body; the board body comprises a left board and a right board; the writing board body also comprises fastening parts; locating parts fastened with the fastening parts are arranged on the left board and the right board; grooves are formed in the locating parts; each fastening part comprises an inverted hooking part; and the inverted hooking parts are embedded into the grooves.

The present invention is further set as: The board body also comprises a plurality of intermediate boards; and the intermediate boards are connected between the left board and the right board in a matching manner through fastening of the locating parts and the fastening parts.

The present invention is further set as: The locating parts are arranged at the edges of four sides of the board body; and the locating parts in the vertical direction comprise a left locating part and a right locating part that are matched in pushing against manner.

The present invention is further set as: The locating parts are detachably connected with the matched board body.

The present invention is further set as: The locating parts are bonded with the matched board body.

The present invention is further set as: The other side of the left locating part or the right locating part, which is opposite to the board body, is provided with an inward recess; the other side of the corresponding right locating part or the corresponding left locating part, which is opposite to the board body, is provided with an outward projection; and the recesses and the projects are matched in shape and size.

The present invention is further set as: The recess is in a V shape.

The present invention is further set as: A connecting piece and a connecting cover are connected between two adjacent locating parts on the same board body, and the connecting cover is sleeved on the connecting piece.

The present invention is further set as: The board body also comprises bending steel boards; each bending steel board comprises a bending part; the locating parts are provided with sunken parts; the bending parts are matched with the sunken parts; and the two adjacent bending parts are connected with each other in a pushing against manner.

The present invention is further set as: The fastening part is a bendable fastening piece, and a notch is formed in the middle part of the fastening piece.

The present invention is further set as: The connecting pieces are plastic corners, and the plastic corners are connected with the locating parts in an insertion manner.

The writing board has the following advantages of reduction of the transportation cost, convenient presentation, simple structure and convenient use and can be lengthened infinitely.

### DESCRIPTION OF DRAWINGS

FIG. 1 is a schematic plan of the back surface of a writing board of the present invention;

FIG. 2 is a structural diagram of the writing board of the present invention;

FIG. 3 is an amplification schematic diagram of a part A of the writing board of the present invention;

FIG. 4 is a local schematic diagram of the writing board of the present invention;

FIG. 5 is a schematic plan of a fastening part of the writing board of the present invention;

FIG. 6 is a schematic plan of a single writing board of the writing board of the present invention;

FIG. 7 is a schematic plan of the positive face of the writing board of the present invention.

In the figures: 1, body; 2, board body; 3, left board; 4, right board; 5, fastening part; 6, locating part; 7, groove; 8, inverted hooking part; 9, paper board; 10, bending steel board; 11, bending part; 12, left locating part; 13, right locating part; 14, recess; 15, projection; 16, barb; 17, connecting cover; 18, connecting piece

### DETAILED DESCRIPTION OF EMBODIMENT

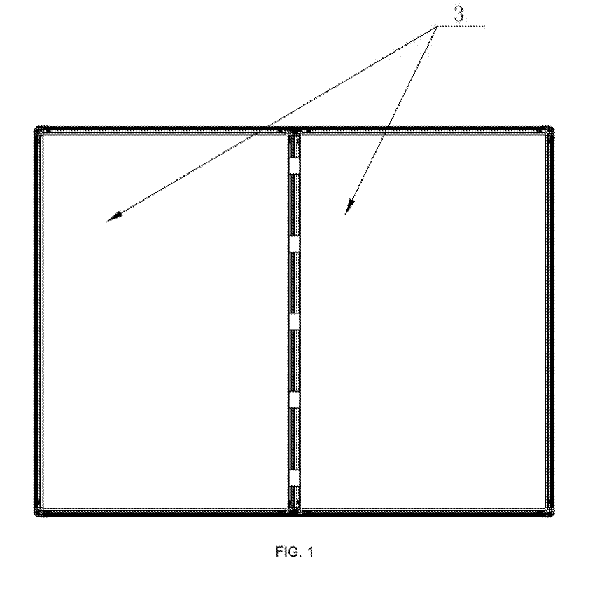

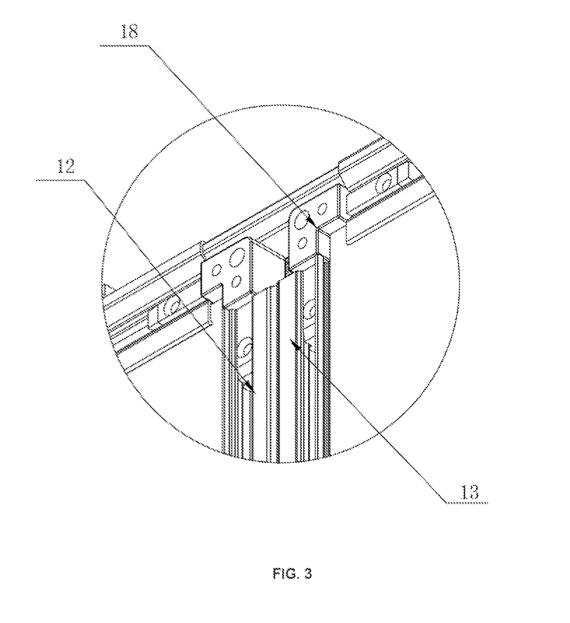

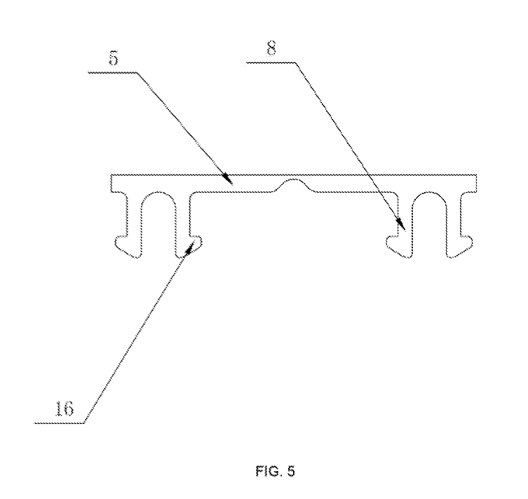

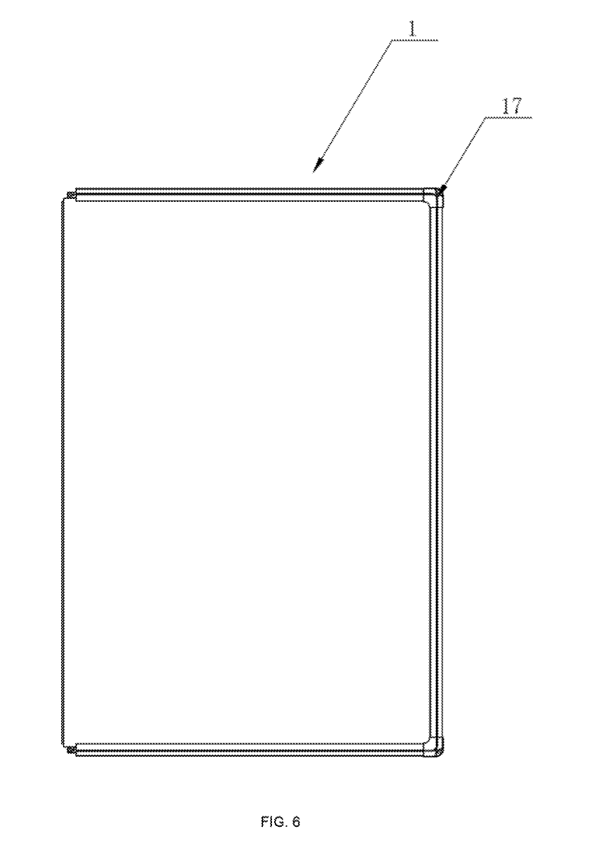

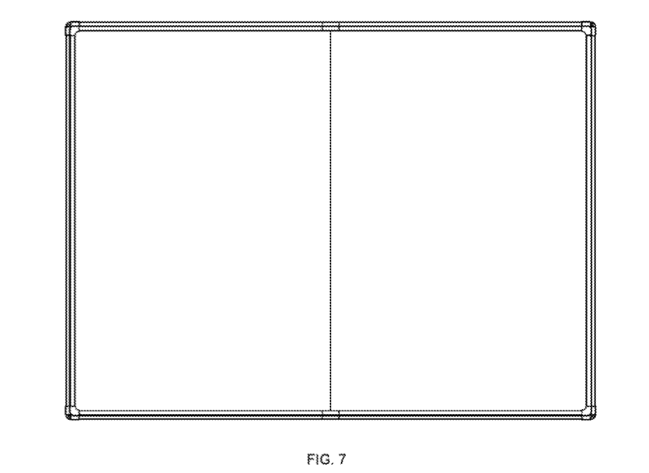

As shown in FIGS. 1-7, the writing board in Embodiment 1 comprises the body 1, wherein the body 1 comprises the board body 2; the board body 2 comprises the left board 3 and the right board 4; the writing board body 1 also comprises the fastening parts 5; the locating parts 6 fastened with the fastening parts 5 are arranged on the left board 3 and the right board 4; grooves 7 are formed in the locating parts 6; each fastening part 5 comprises the inverted hooking part 8; and the inverted hooking parts 8 are embedded into the grooves 7.

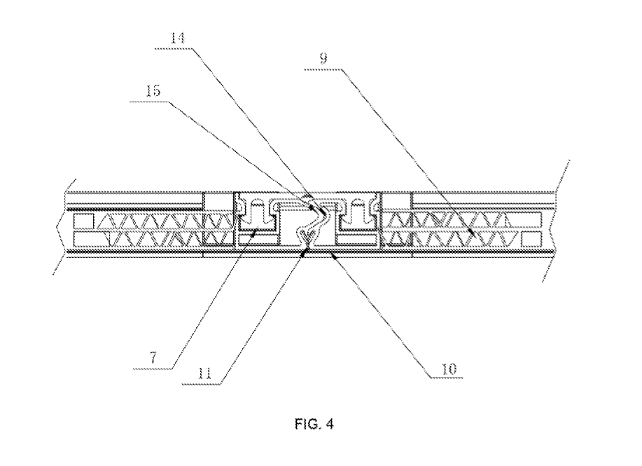

The left board 3, the right board 4 and the intermediate board comprise paper boards 9 and the bending steel boards 10; the paper boards 9 and the bending steel boards 10 are arranged in a gluing manner; the bending part 11 is integrally formed at one end of each bending steel board 10, as shown in FIG. 4, half of the paper boards 9 are wrapped by the bending steel boards 10, and the bending part 11 is arranged at one side of each of the paper board 9; the locating parts 6 are preferably aluminum strips and are arranged at the edges of the four sides of the board body 2 for wrapping the board body 2; therefore, the locating parts 6 are horizontally and vertically arranged on the board body 2; the locating parts 6 are detachably connected with the matched board body 2 (such as the insertion matching manner); the locating parts 6 are also fixed with the matched board body 2 in a bonding manner, and the bonding manner is preferably selected in the embodiment, wherein the locating parts 6 in the vertical direction comprise the left locating part 12 and the right locating part 13 that are matched in a pushing against manner; the other side of the left locating part 12 or the right locating part 13, which is opposite to the board body 2, is provided with the inward recess 14, and the other side of the corresponding right locating part 13 or the corresponding left locating part 12, which is opposite to the board body 2, is provided with the outward projection 15, the recess 14 is in a V shape or U shape, the opening narrows down gradually along the bottom in the overall shape, as shown in FIG. 4, and the recesses 14 and the projects 15 are matched in shape and size.

The left locating part 12 and the right locating part 13 are provided with the grooves 7, as shown in FIG. 4, the cross section of the groove 7 is in a convex shape at the opening of the upper end, the fastening parts 5 are fastened with the left locating part 12 and the right locating part 13, the fastening parts 5 is preferably the bendable fastening piece, and the middle part of the fastening piece is provided with the notch, the fastening part is divided into two parts by the notch, the two parts are connected with each other left and right and can be folded 180 degrees, and the fastening piece cannot be fractured; the fastening piece comprises barbs 16 at the two ends of the fastening piece, the two barbs 16 are respectively embedded into the two corresponding grooves, after the barbs 16 stretches into the grooves 7, the tips of the barbs 16 are arranged in the grooves 7 in a pushing against way, and the fastening piece is fastened with the locating parts 6 in a tightening manner.

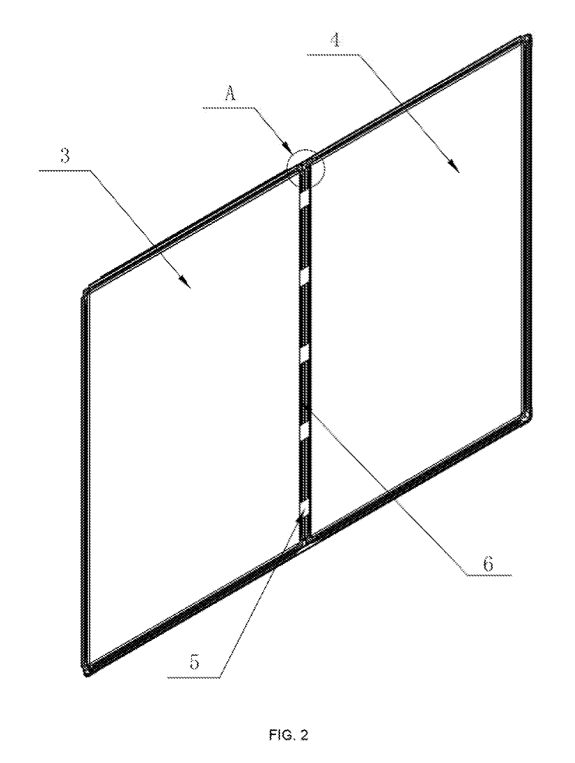

The board body 2 comprises the paper boards 9 and the bending steel boards 10; each bending steel board 10 comprises the bending part 11; the locating parts 6 are also provided with the sunken parts, as shown in FIG. 4; the bending parts 11 are matched with the sunken parts; the two adjacent bending parts 11 are connected with each other in a pushing against manner; the bending parts 11 and the locating parts 6 are fastened together and can locate each other, thereby solving the problem that the positive face of the writing board is not flat. When in installation, the locating parts are arranged at the edges of the four sides of the left board 3 and the right board 4 of the board body 2, a plurality of fastening parts 5 are sequentially fastened on the locating parts 6, and the left board 3 and the right board 4 are connected with each other in the above manner to form the whole writing board. Similarly, a plurality of intermediate boards can be inserted between the left board 3 and the right board 4, the intermediate boards are connected between the left board 3 and the right board 4 through the fastening and matching of the locating parts 6 and the fastening parts 5, so that the writing board can be lengthened infinitely. As shown in FIG. 2, the left board 3, the intermediate boards and the right board 4 are detachably connected; therefore, the writing board is convenient in assembly and disassembly. When in transportation, the left board 3, the intermediate boards and the right board 4 are folded; therefore, the transportation space of the writing board is greatly reduced; especially, the transportation area of the transportation vehicle can be reduced, and the writing board is simple in overall structure and convenient in use.

In addition, the connecting piece 18 and the connecting cover 17 are connected between two adjacent locating parts 6 on the same board body 2; the connecting piece 18 is preferably the plastic corners; the connecting cover 17 is sleeved on the connecting piece 18; and the insertion connecting manner can ensure convenient assembly and disassembly.

The above contents are the preferred embodiment of the present invention, and the protection scope of the present invention is not limited to the above embodiment. Technical solutions under the concept of the present invention belong to the protection scope of the present invention. It should be noted that for those skilled in the art, several variations and improvements can also be made without departing from the principle of the present invention, which belong to the protection scope of the present invention.

We claim:

1. A writing board, comprising a body, wherein the board body comprises a board body; the board body comprises a left board and a right board; the writing board is characterized in that the body also comprises fastening parts; locating parts fastened with the fastening parts are arranged on the left board and the right board; grooves are formed in the locating parts; each fastening part comprises an inverted hooking part; and the inverted hooking parts are embedded into the grooves.

2. The writing board according to claim 1, characterized in that: the board body also comprises a plurality of intermediate boards; and the intermediate boards are connected between the left board and the right board in a matching manner through fastening of the locating parts and the fastening parts.

3. The writing board according to claim 2, characterized in that: the locating parts are arranged at the edges of four sides of the board body; and the locating parts in the vertical direction comprise a left locating part and a right locating part that are matched in pushing against manner.

4. The writing board according to claim 3, characterized in that: the locating parts are detachably connected with the matched board body.

5. The writing board according to claim 3, characterized in that: the locating parts are bonded with the matched board body.

6. The writing board according to claim 3, characterized in that: the other side of the left locating part or the right locating part, which is opposite to the board body, is provided with an inward recess; the other side of the corresponding right locating part or the corresponding left locating part, which is opposite to the board body, is provided with an outward projection; and the recesses and the projects are matched in shape and size.

7. The writing board according to claim 3, characterized in that: the recess is in a V shape.

8. The writing board according to claim 3, characterized in that: a connecting piece and a connecting cover are connected between two adjacent locating parts on the same board body, and the connecting cover is sleeved on the connecting piece.

9. The writing board according to claim 1, characterized in that: the board body also comprises bending steel boards; each bending steel board comprises a bending part; the locating parts are provided with sunken parts; the bending parts are matched with the sunken parts; and the two adjacent bending parts are connected with each other in a pushing against manner.

10. The writing board according to claim 1, characterized in that: the fastening part is a bendable fastening piece, and a notch is formed in the middle part of the fastening piece.

11. The writing board according to claim 8, characterized in that: the connecting pieces are plastic corners, and the plastic corners are connected with the locating parts in an insertion manner.
